(19) United States
(12) Patent Application Publication
(10) Pub. No.: US 2015/0082898 A1
(43) Pub. Date: Mar. 26, 2015

(54) STRAIN SENSOR

(71) Applicant: Panasonic Intellectual Property Management Co., Ltd., Osaka (JP)

(72) Inventor: HIDEO OHKOSHI, Osaka (JP)

(21) Appl. No.: 14/554,982

(22) Filed: Nov. 26, 2014

Related U.S. Application Data
(63) Continuation of application No. PCT/JP2013/003717, filed on Jun. 13, 2013.

(30) Foreign Application Priority Data
Jun. 25, 2012 (JP) 2012-141570

(51) Int. Cl. G01L 1/10

(52) U.S. Cl. CPC G01L 1/10
USPC 73/778; 73/763

(57) ABSTRACT

A strain sensor includes a package to be connected to a strain generating body, a detector configured to convert a mechanical strain of the strain generating body into an electric signal and output the electric signal, and a processor chip connected to an upper surface of the package and separated from a detector. A recess is provided in the upper surface of the package. The detector is accommodated in the recess and joined to the recess. This strain sensor can have a small size.

This application is a continuation of International Application PCT/JP2013/003717, filed on Jun. 13, 2013, claiming the foreign priority of Japanese Patent Application No. 2012-141570, filed on Jun. 25, 2012, the contents of which are incorporated herein by reference.

### TECHNICAL FIELD

The present invention relates to a strain sensor that detects a mechanical strain generated in an object due to a load applied to the object.

### BACKGROUND ART

A microfabrication technique, such as Micro Electro Mechanical Systems (MEMS) technique, can provide a mechanical vibrator that is extremely small and thin. This technique realizes a small mass of the vibrator itself, and a high precision vibrator in which frequency and impedance greatly change even when a load to be applied is small. This micromechanical vibrator does not require making stress concentration points in the strain generating body itself. Therefore, the micromechanical vibrator attached to the strain generating body can provide a strain sensor that can easily measure load and strain applied to the strain generating body.

### CITATION LIST

### Patent Literature

PTL 1: Japanese Patent Laid-Open Publication No. 03-103735

### SUMMARY

A strain sensor includes a package to be connected to a strain generating body, a detector converting a mechanical strain of the strain generating body into an electric signal and output the electric signal, and a processor chip connected to the upper surface of the package and separated from the detector. A recess is provided in the upper surface of the package. The detector is accommodated in the recess and joined to the recess.

This strain sensor can have a small size.

### BRIEF DESCRIPTION OF DRAWINGS

FIG. 1 is an exploded perspective view of a strain sensor according to an exemplary embodiment of the present invention.

FIG. 2 is a cross-sectional view of the strain sensor according to the embodiment.

FIG. 3A is a bottom view of a detector of the strain sensor according to the embodiment.

FIG. 3B is a cross-sectional view of the detector at line 3B-3B shown in FIG. 3A.

FIG. 3C is an enlarged cross-sectional view of the detector shown in FIG. 3B.

FIG. 3D is an enlarged cross-sectional view of another strain sensor according to the embodiment.

FIG. 3E is an enlarged cross-sectional view of a still another strain sensor according to the embodiment.

FIG. 3F is a bottom view of a detector of a further strain sensor according to the embodiment.

### DETAIL DESCRIPTION OF PREFERRED EMBODIMENT

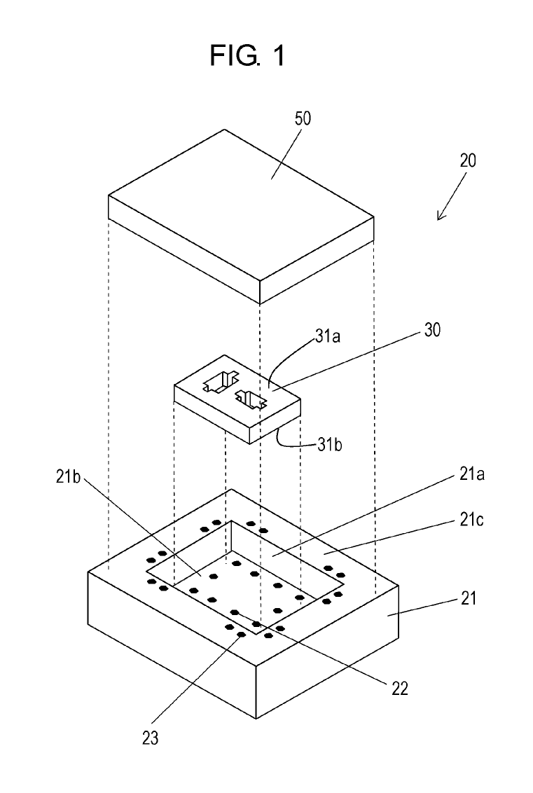

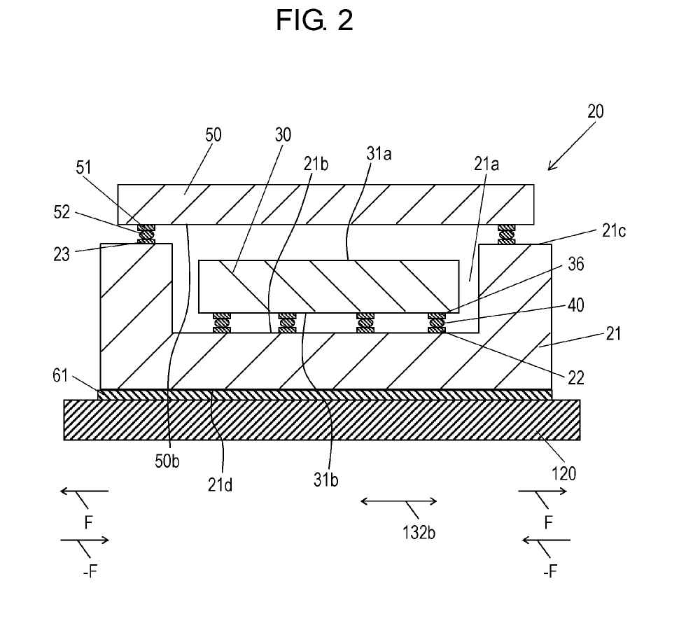

FIGS. 1 and 2 are an exploded perspective view and a cross-sectional view of strain sensor 20 according to an exemplary embodiment of the present invention, respectively. Strain sensor 20 is to detect a mechanical strain of strain generating body 120, and includes package 21, detector 30, and processor chip 50. According to the embodiment, processor chip 50 is an integrated circuit (IC) chip. Package 21 includes a wiring board, such as a multilayer printed wiring board or a multilayer ceramic substrate. Upper surface 21c of package 21 has recess 21a therein at substantially at a center of the upper surface. Recess 21a opens upward and has bottom surface 21b facing upward. Electrode pad 22 is provided on bottom surface 21b of recess 21a. Electrode pad 23 plated with gold is provided on upper surface 21c of package 21. Inner electrodes of package 21 electrically connect between electrode pads 22 and 23, or between an external electrode provided on lower surface 21d of package 21 and each of electrode pads 22 and 23. Detector 30 is made of a silicon material-based substrate, such as a Silicon-On-Insulator (SOI) substrate, and converts a physical amount, such as a tensile force and a strain, into an electric signal. Processor chip 50 processes the electric signal output from detector 30, and provides an electric signal corresponding to the physical amount, such as the tensile force and the load, applied to strain sensor 20. Electrode pad 51 is provided on lower surface 50b of processor chip 50 at a position opposed to electrode pad 23. Bump 52 containing metal, such as gold, is formed on electrode pad 51. Lower surface 21d of package 21 is connected and fixed to strain generating body 120 with bonding member 61 containing metal-based material, such as Au—Au joining, or a material, such as an epoxy resin, having stiffness.

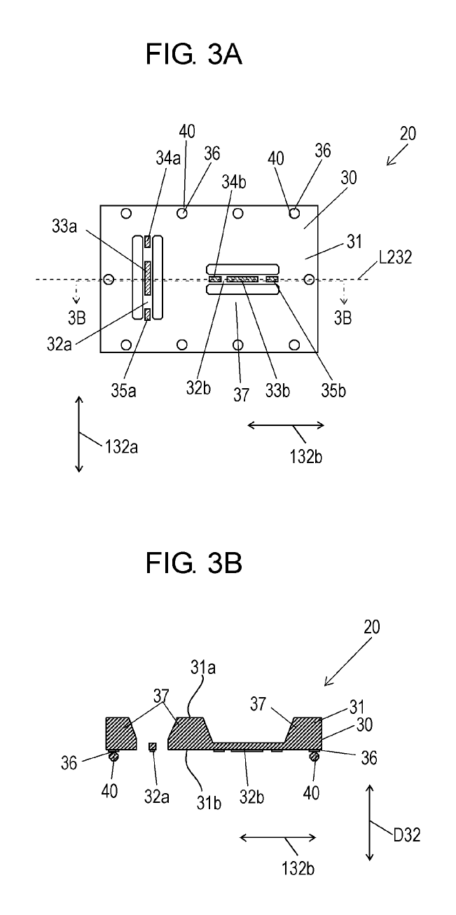

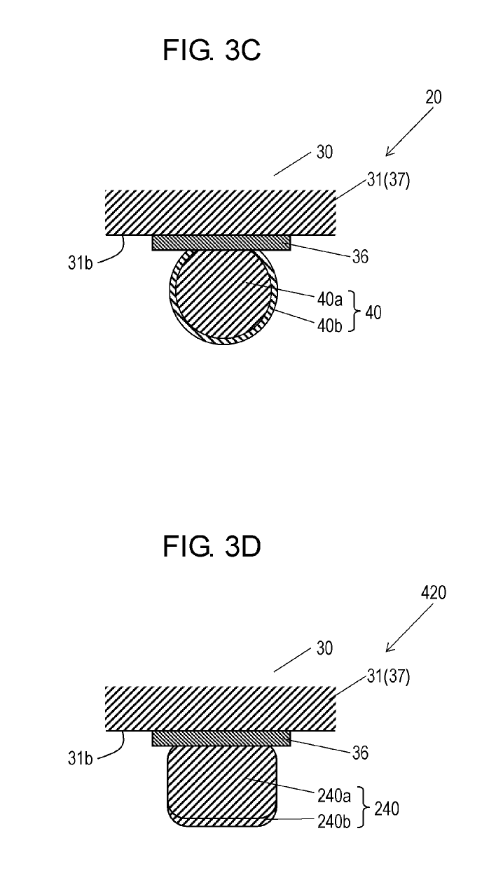

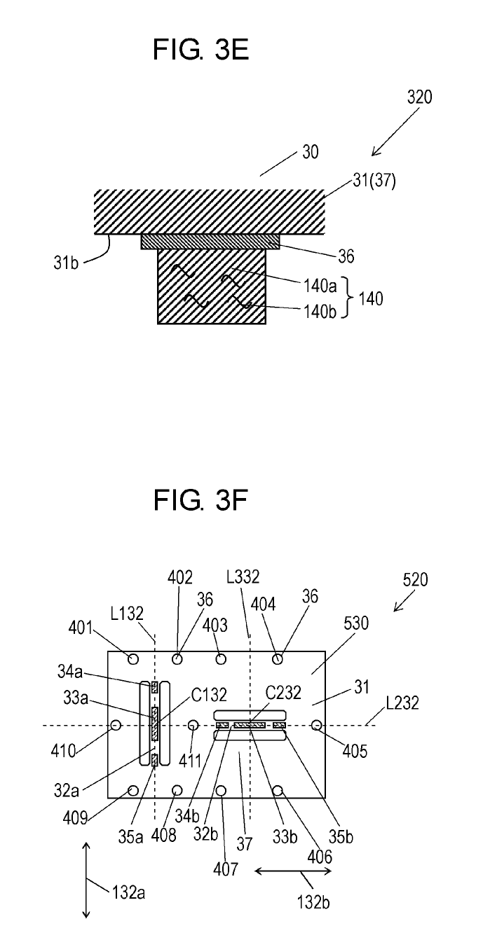

FIG. 3A is a bottom view of detector 30 of strain sensor 20. FIG. 3B is a cross-sectional view of detector 30 at line 3B-3B shown in FIG. 3A. Detector 30 includes substrate 31 that is made of a semiconductor material, such as silicon, and has a rectangular shape. Substrate 31 has upper surface 31a and lower surface 31b. Substrate 31 includes base 37, and vibrators 32a and 32b that are connected to base 37. Base 37 and vibrators 32a and 32b are formed by etching upper surface 31a and lower surface 31b of substrate 31. Vibrators 32a and 32b are arranged along lower surface 31b of substrate 31. Vibrator 32a has a beam shape having both ends connected to base 37, and extends slenderly along longitudinal direction 132a that connects both ends. Vibrator 32b has a beam shape having both ends connected to base 37, and extends slenderly along longitudinal direction 132b that connects both ends. Vibrator 32a has a length of 0.55 mm in longitudinal direction 132a of vibrator 32a, a width of 0.15 mm, and a thickness of 0.01 mm. Vibrator 32b has a length of 0.60 mm in longitudinal direction 132b of vibrator 32b, a width of 0.15 mm, and a thickness of 0.01 mm. According to the embodiment, vibrators 32a and 32b are arranged, such that lower surface 31b of substrate 31 has a rectangular shape, longitudinal direction 132a of vibrator 32a is parallel to one side of the rectangular shape of substrate 31, and longitudinal direction 132a of vibrator 32a is perpendicular to longitudinal direction 132b of vibrator 32b.

Detector 30 further includes drive element 33a provided at a center part of the beam shape of vibrator 32a, and sensing elements 34a and 35a provided respectively close to both ends of the beam shape. Each of drive element 33a, sensing element 34a, and sensing element 35a includes a grounded electrode provided on a surface of vibrator 32a, a piezoelectric body layer made of a piezoelectric material, such as PZT, provided on the grounded electrode, and an upper electrode provided on the piezoelectric body layer. Six electrodes: the upper electrode and the ground electrode of drive element 33a; the upper electrodes of sensing elements 34a and 35a; and the ground electrodes of sensing elements 34a and 35a are electrically connected to land 36 by a wiring pattern. Bump 40 is provided on the lower surface of land 36.

FIG. 3C is an enlarged cross-sectional view of detector 30 shown in FIG. 3B, and illustrates a periphery of bump 40. Bump 40 includes core 40a and solder 40b that covers the surface of core 40a. According to embodiment, core 40a is made of metal, such as gold, and has a spherical shape.

Detector 30 further includes drive element 33b provided at a center part of the beam shape of vibrator 32b, and sensing elements 34b and 35b provided respectively close to both ends of the beam shape. Each of drive element 33b, sensing element 34b, and sensing element 35b includes a grounded electrode provided on the surface of vibrator 32b, a piezoelectric body layer made of a piezoelectric material, such as PZT, provided on the grounded electrode, and an upper electrode provided on the piezoelectric body layer. Six electrodes: the upper electrode and the ground electrode of drive element 33b; the upper electrodes of sensing elements 34b and 35b; and the grounded electrodes of sensing elements 34b and 35b are electrically connected to land 36 by a wiring pattern.

As illustrated in FIGS. 1 and 2, lower surface 31b which has vibrators 32a and 32b of detector 30 and land 36 formed thereon faces bottom surface 21b of recess 21a that is formed on the upper surface 21c of package 21. Electrode pad 22 is provided at the bottom surface 21b of recess 21a. Land 36 and electrode pad 22 are electrically and mechanically joined to each other by melting and solidifying solder 40b on the surface of bump 40. Electrode pad 51 of processor chip 50 is electrically and mechanically joined to electrode pad 23 provided on upper surface 21c of package 21 by applying ultrasound while interposing bump 52 between electrode pads 23 and 51 and applying pressure.

An operation of strain sensor 20 will be described below. When an alternating-current (AC) voltage having a frequency around natural frequency f1 of vibrator 32a (200 kHz according to the embodiment) is applied from processor chip 50 to drive element 33a, drive element 33 causes a mechanical vibration. The mechanical vibration causes vibrator 32a to start a string vibration in vertical direction D32 at natural frequency f1. The string vibration is sensed by sensing elements 34a and 35a, and an AC signal having a frequency equal to natural frequency f1 is fed back from sensing elements 34a and 35a to processor chip 50. This configuration allows vibrator 32a to continue the string vibration at a frequency equal to natural frequency f1. Similarly, when an AC voltage having a frequency around natural frequency f2 of vibrator 32b (165 kHz according to the embodiment) is applied from processor chip 50 to drive element 33b, drive element 33b causes a mechanical vibration. The mechanical vibration causes vibrator 32b to start a string vibration in vertical direction D32 at natural frequency f2. The string vibration is sensed by sensing elements 34b and 35b, and an AC signal having a frequency equal to natural frequency f2 is fed back from sensing elements 34b and 35b to processor chip 50. This configuration allows vibrator 32b to continue the string vibration at a frequency equal to natural frequency f2.

As illustrated in FIG. 2, when tensile force F in longitudinal direction 132b of vibrator 32b is applied to strain generating body 120, vibrator 32b extends in longitudinal direction 132b and vibrator 32a contracts in longitudinal direction 132a of vibrator 32a by a length corresponding to a Poisson ratio of strain generating body 120. This action increases the frequency of vibration of vibrator 32a from frequency f1 to frequency (f1+Δa), and decreases the frequency of vibration of vibrator 32b from frequency f2 to frequency (f2−Δb). When compressive force −F in longitudinal direction 132b is applied to strain generating body 120, vibrator 32b contracts in longitudinal direction 132b and vibrator 32a extends in longitudinal direction 132a of vibrator 32a by a length corresponding to a Poisson ratio of strain generating body 120. This action decreases the frequency of vibration of vibrator 32a from frequency f1 to frequency (f1−Δa), and increases the frequency of vibration of vibrator 32b from frequency f2 to frequency (f2+Δb). Processor chip 50 processes AC signals having the frequencies generated by drive element 33a of vibrator 32a and drive element 33b of vibrator 32b, and outputs a signal having difference δ between the frequencies of the AC signals. When tensile force F is applied to strain generating body 120, difference δ between the frequencies is expressed as follows.

δ=(fa+Δa)−(fb−Δb)=(fa−fb)+(Δa+Δb)

Difference δ between the frequencies is larger than a change in frequency of vibration of a stand-alone vibrator. By measuring difference δ between the frequencies, strain sensor 20 can sensitively measure strain and load that are applied to strain generating body 120.

A pair of bumps 40 out of plural bumps 40 are located on lower surface 31b of detector 30, and arranged symmetrically to each other with respect to center line L232 in which the beam shape of vibrator 32b extends. This configuration allows thermal stress due to a difference of thermal expansion coefficients of package 21 and detector 30 to be applied evenly to vibrator 32b, and suppresses fluctuations in temperature characteristics and sensitivity. Therefore, strain sensor 20 can sensitively detect a physical amount, such as a tensile force and a strain applied to strain generating body 120.

For example, when an IC processor chip using silicon is used in a conventional strain sensor, detection accuracy may be degraded by expansion of signal errors or degradation of a signal during the signal process due to a piezoelectric effect or the like.

On the other hand, in strain sensor 20 according to the embodiment, vibrators 32a and 32b changing the frequency of vibration according to a tensile force or a strain are electrically and mechanically connected by the shortest distance via bump 40 to bottom surface 21b of recess 21a of package 21 that is connected to strain generating body 120. Hence, the strain applied to strain generating body 120 is effectively transmitted to vibrators 32a and 32b. This configuration can secure a high S/N ratio even when the force applied to strain generating body 120 is small. Moreover, bump 40 including core 40a can secure a predetermined gap between bottom surface 21b of recess 21a of package 21 and each of vibrators 32a and 32b, hence not preventing the vibrations of vibrators 32a and 32b. By melting and solidifying solder 40b that covers the surface of core 40a of bump 40 with, e.g. a reflow furnace in a high temperature atmosphere, land 36 of detector 30 is electrically and mechanically joined to electrode pad 22 on bottom surface 21b of recess 21a of package 21. Therefore, the above configuration provides smaller residual stress caused by a difference between thermal expansion coefficients of package 21 and detector 30 is applied more evenly to vibrators 32a and 32b than the connection with ultrasound adhesion using bump made of gold. Therefore, a variation of the frequency of vibration related to mounting can be almost zero. Strain sensor 20 according to the embodiment can secure a high S/N ratio even when a force applied to strain generating body 120 is small, and can sensitively detect the strain applied to strain generating body 120 by suppressing fluctuations in temperature characteristics and sensitivity.

Since processor chip 50 is disposed away from strain generating body 120 on upper surface 21c of package 21, strain applied to strain generating body 120 can hardly be transmitted to processor chip 50. Therefore, processor chip 50 can be connected to upper surface 21c of package 21 with bump 52 made of a general material, such as gold, instead of a material having high flexibility, and can increase connection reliability. Furthermore, since detector 30 and processor chip 50 are connected to package 21 with bump 40 and bump 52, respectively, a bonding wire is not necessary. This configuration provides strain sensor 20 with a small size a thin profile, and allows strain sensor 20 to precisely detect the physical amount, such as a tensile force or a strain.

FIG. 3D is an enlarged cross-sectional view of another strain sensor 420 according to the embodiment. In FIG. 3D, components identical to those of strain sensor 20 shown in FIG. 3C are denoted by the same reference numerals. Strain sensor 420 includes bump 240 that connects land 36 of detector 30 to electrode pad 22 of package 21, instead of bump 40 of strain sensor 20 shown in FIG. 3C. Bump 240 includes core 240a and solder 240b that covers at least a part of the surface of core 240a. According to the embodiment, core 240a is made of metal, such as gold, and has a spherical shape.

FIG. 3E is an enlarged cross-sectional view of still another strain sensor 320 according to the embodiment. In FIG. 3E, components identical to those of strain sensor 20 shown in FIG. 3C are denoted by the same reference numerals. Strain sensor 320 includes bump 140 that connects land 36 of detector 30 to electrode pad 22 of package 21, instead of bump 40 of strain sensor 10 shown in FIG. 3C. Bump 140 includes thermosetting conductive adhesive 140b that contains spacer 140a, providing the same effect.

Bump 52 that joins processor chip 50 to upper surface 21c of package 21 may be made of a thermosetting conductive adhesive, providing the same effect.

FIG. 3F is a bottom view of detector 530 of further strain sensor 520 according to the embodiment. In FIG. 3F, components identical to those of detector 30 shown in FIG. 3A are denoted by the same reference numerals. Detector 530 of strain sensor 520 includes bumps 401 to 411 instead of bump 40 of detector 30 shown in FIG. 3A. Each of bumps 401 to 411 of detector 530 of strain sensor 520 is the same as bump 40 of detector 30 shown in FIG. 3A. The beam shapes of vibrators 32a and 32b extend slenderly along center lines L132 and L232, respectively. Center lines L132 and L232 pass through center C132 of the beam shape of vibrator 32a and center C232 of the beam shape of vibrator 32b, respectively. Center line L322 passes through center C232 of vibrator 32b and crosses center line L232 perpendicularly to center line L232. Center lines L132 and L232 cross at center C132 of vibrator 32a perpendicularly to each other. Center lines L132 and L232 cross at center C132 of vibrator 32a perpendicularly to each other. Bumps 401, 410, and 409 are arranged symmetrically to bumps 402, 411, and 408 with respect to center line L132, respectively. Bumps 401, 410, and 409 are arranged symmetrically to bumps 408, 411, and 402 with respect to center C132, respectively. Bumps 401 and 402 are arranged symmetrically to bumps 409 and 408 with respect to center line L232, respectively. Bumps 405, 410, and 411 are arranged on center line L232. Bumps 403, 411, and 407 are arranged symmetrically to bumps 404, 405, and 406 with respect to center line L332, respectively. Bumps 403, 411, and 407 are arranged symmetrically to bumps 406, 405, and 404 with respect to center C232 of vibrator 32b, respectively. Bumps 403 and 404 are arranged symmetrically to bumps 407 and 406 with respect to center line L232, respectively. This arrangement allows thermal stress due to a difference of thermal expansion coefficients of package 21 and detector 530 to be applied evenly to vibrator 32b, and suppresses fluctuations in temperature characteristics and sensitivity. Strain sensor 520 can precisely detect the physical amount, such as the tensile force and the strain, applied to strain generating body 120.

In the embodiment, terms, such as “upper surface”, “lower surface”, and “upward”, indicating directions merely indicate relative directions that depend only on a relative positional relationship of structural components, such as package 21 and detector 30, of strain sensor 20, and do not indicate absolute directions, such as a vertical direction.

The strain sensors according to the embodiment are effective as a strain sensor having a small size and thin profile and precisely detecting a physical amount, such as a tensile force or a strain, and are useful for a strain sensor that detects a strain and load applied to an object.

### REFERENCE MARKS IN THE DRAWINGS

20 strain sensor
21 package
30 detector
32a, 32b vibrator
40 bump (first bump)
50 processor chip
52 bump (second bump)

What is claimed is:

1. A strain sensor to detect a mechanical strain of a strain generating body, the strain sensor comprising:
a package having an upper surface and a lower surface, the upper surface having a recess formed therein, the lower surface being connected to the strain generating body;
a detector accommodated in the recess and joined to the recess, the detector converting the mechanical strain into an electric signal and outputting the electric signal; and
a processor chip connected to the upper surface of the package and separated from the detector, the processor chip configured to process the electric signal output from the detector.

2. The strain sensor according to claim 1, further comprising a first bump that joins the detector to the recess.

3. The strain sensor according to claim 2, wherein the first bump comprises a thermosetting conductive adhesive including a spacer.

4. The strain sensor according to claim 2, wherein the first bump includes a core and a solder that covers at least a part of a surface of the core.

5. The strain sensor according to claim 2,
wherein the detector includes a vibrator having a vibration changed according to the mechanical strain,
wherein the vibrator is provided at a lower surface of the detector, and
wherein the first bump joins the lower surface of the detector to the recess of the package.

6. The strain sensor according to claim 5, wherein the first bump comprises at least four bumps which surround the vibrator in plan view.

7. The strain sensor according to claim 6, wherein at least two bumps of the first bump are positioned in parallel to an extending direction of the vibrator.

8. The strain sensor according to claim 2, further comprising a second bump that electrically and mechanically connects the processor chip to the upper surface of the package.

9. The strain sensor according to claim 2, further comprising a second bump that electrically and mechanically connects the processor chip to the upper surface of the package,
wherein the second bump comprises at least four bumps which surround the first bump.

10. The strain sensor according to claim 8, wherein the second bump comprises a thermosetting conductive adhesive.

11. The strain sensor according to claim 1, further comprising a bump that electrically and mechanically connects the processor chip to the upper surface of the package.

12. The strain sensor according to claim 11, wherein the bump comprises a thermosetting conductive adhesive.

13. A strain sensor to detect a mechanical strain of a strain generating body, the strain sensor comprising:
a package having an upper surface and a lower surface, the upper surface having a recess therein, the lower surface connected to the strain generating body;
a detector accommodated in the recess and joined to the recess, the detector converting the mechanical strain into an electric signal and outputting the electric signal; and
a processor chip connected to the upper surface of the package and separated from the detector, the processor chip processing the electric signal output from the detector,
wherein the detector is joined to the recess with a thermosetting conductive adhesive that includes a spacer or with a first bump having a core and a solder that covers at least a part of a surface of the core, and
wherein the processor chip is electrically and mechanically connected to the upper surface of the package with a second bump that includes a thermosetting conductive adhesive.
